(19) United States
(12) Patent Application Publication
(10) Pub. No.: US 2012/0182751 A1
(43) Pub. Date: Jul. 19, 2012

(54) FIXING BASE STRUCTURE OF VEHICULAR LAMP ADJUSTMENT MECHANISM

(75) Inventor: Kuo-Pin WU, Tainan City (TW)

(73) Assignee: MAXZONE AUTO PARTS CORP., Fontana, CA (US)

(21) Appl. No.: 13/348,689

(22) Filed: Jan. 12, 2012

(30) Foreign Application Priority Data
Jan. 14, 2011 (TW) 100200906

(51) Int. Cl. F21V 21/14

(52) U.S. Cl. 362/523

(57) ABSTRACT

A fixing base structure of a vehicular lamp adjustment mechanism, applicable to different ball heads, includes a clamping element, a ball head, and a fixing base. The clamping element includes a ball head chamber, a flange, and a positioning portion. The ball head chamber has an opening and a spherical space. The flange protrudes toward the outer side of the opening of the ball head chamber. The positioning portion protrudes toward the inner side of the opening of the ball head chamber. The inner side of the positioning portion has an arcuate conical surface correspondingly connected to the ball head chamber. The least diameter between the arcuate conical surfaces is less than a diameter of the spherical space. The ball head is clamped and confined to the ball head chamber by the positioning portion. The clamping element is received in the fixing base.

### FIELD OF THE INVENTION

The present invention relates to vehicular lamp adjustment devices, and more particularly, to a fixing base structure for use with ball heads of different types.

### BACKGROUND OF THE INVENTION

Development of vehicles is ever-changing and thus brings much convenience to our daily life. Drivers on the roads should not only take care of their own safety, but also have social responsibility toward pedestrians or other vehicles on the roads, so as to ensure their safety. In particular, headlamps of vehicles in motion not only provide illumination but also serve as warning to others.

To adjust a reflector of a headlamp, related prior art requires disposing a recess in the fixing base and forming a pair of resilient bumps on the two inner walls at the entrance of the recess, such that the bumps expand outward as soon as a ball head passes the bumps, and the bumps restore original states thereof to form a blockade for preventing disconnection of the ball head as soon as the ball head enters the recess. However, the fixed length of the conventional bumps poses a problem. In the situation where ball heads of different specifications enter the recess, seamless adhesion between the inner wall of a ball head of a specific shape and the inner wall of the recess is impossible, not to mention that a ball head of a specific shape (a hemispherical ball head or a three-fourths ball head) can have excessive allowance and thus tends to shake. Hence, the conventional fixing base is ineffective in adapting to ball heads of different specifications.

### BRIEF SUMMARY OF THE INVENTION

In a technical aspect, the present invention provides a fixing base structure of a vehicular lamp adjustment mechanism with a view to overcoming a drawback of the prior art, that is, difficulty in adapting to ball heads of different specifications and preventing the ball heads from shaking.

According to an embodiment of this technical aspect, a fixing base structure of a vehicular lamp adjustment mechanism comprises a clamping element, a ball head, and a fixing base. The clamping element further comprises a ball head chamber, a flange, and a positioning portion. The ball head chamber is formed on the clamping element. The ball head chamber has an opening and a spherical space. The flange protrudes toward the outer side of the opening of the ball head chamber. The positioning portion protrudes toward the inner side of the opening of the ball head chamber. The inner side of the positioning portion has an arcuate conical surface correspondingly connected to the ball head chamber. The least diameter between the arcuate conical surfaces is less than the diameter of the spherical space of the ball head chamber. The ball head is clamped and confined to the ball head chamber by means of the positioning portion of the clamping element. The clamping element is received in the fixing base. The fixing base further comprises a receiving chamber and an engaging portion. The receiving chamber is formed on the fixing base. The receiving chamber has an opening. The clamping element is tightly disposed in the receiving chamber. The engaging portion protrudes toward the inner side of the opening of the receiving chamber. The flange of the clamping element is positioned in place when engaged with the engaging portion.

According to another embodiment of this technical aspect, the positioning portion of the clamping element of the vehicular lamp adjustment mechanism is circumferentially fixed to the inner side of the opening of the ball head chamber. The positioning portion has an oblique conical surface slanting and extending toward the center. The engaging portion has an oblique conical surface, and the oblique conical surface is correspondingly connected to the oblique conical surface of the positioning portion. The outer side of the flange of the clamping element has an oblique conical surface corresponding to the oblique conical surface on the inner side of the engaging portion. The ball head of the vehicular lamp adjustment mechanism is a full ball head or a three-fourths ball head.

In another embodiment of this technical aspect, a fixing base structure of a vehicular lamp adjustment mechanism comprises a hierarchical structure integrally formed with the outer side of the opening of the receiving chamber. Hollow portions are formed in the hierarchical structure to penetrate the hierarchical structure. Extension-contraction slots are formed at the ball head chamber of the clamping element. For example, two extension-contraction slots are formed on two opposing sides of the ball head chamber of the clamping element, respectively. Furthermore, support portions are integrally fixed to the outer side of the fixing base and extend in a direction parallel to a virtual central axis of the fixing base. Eventually, it is feasible to have a bolt pivotally disposed at the bottom of the fixing base for screwing the fixing base to a preset position.

Accordingly, in the aforesaid embodiments of this technical aspect, a fixing base structure of a vehicular lamp adjustment mechanism is fully applicable to ball heads of different specifications by the ball head chamber and the positioning portion of the clamping element. Furthermore, the flange of the clamping element is engaged with the engaging portion of the fixing base to not only fix the clamping element to the fixing base firmly but also prevent the ball head from escaping from the ball head chamber.

### BRIEF DESCRIPTION OF THE SEVERAL VIEWS OF THE DRAWINGS

FIG. 1 is a perspective view of a fixing base structure of a vehicular lamp adjustment mechanism according to an embodiment of the present invention;

FIG. 2 is an exploded view of the fixing base structure of a vehicular lamp adjustment mechanism of FIG. 1;

FIG. 3 is a cross-sectional view of the fixing base structure of a vehicular lamp adjustment mechanism taken along line 1-1 in FIG. 1; and

FIG. 4 is a partial enlarged view of the fixing base structure of a vehicular lamp adjustment mechanism of FIG. 3.

### DETAILED DESCRIPTION OF THE EMBODIMENTS OF THE INVENTION

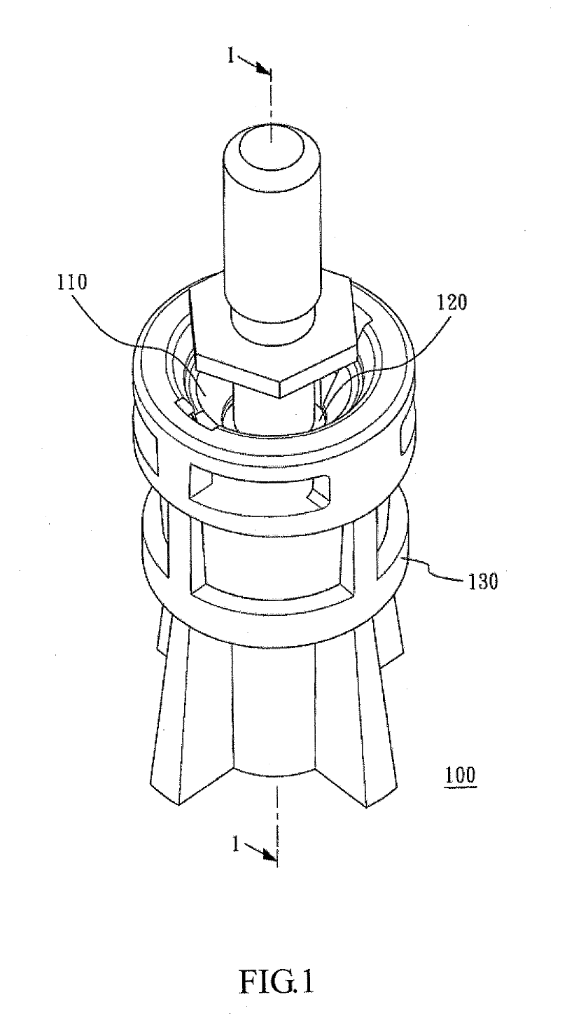

FIG. 1 is a perspective view of a fixing base structure of a vehicular lamp adjustment mechanism 100 according to an embodiment of the present invention. As shown in FIG. 1, the fixing base structure of a vehicular lamp adjustment mechanism 100 comprises a clamping element 110, a ball head 120 and a fixing base 130. In this embodiment, the fixing base structure of a vehicular lamp adjustment mechanism 100 involves installing the ball head 120 in the clamping element 110, inserting the clamping element 110 and the ball head 120 into the fixing base 130, clamping and positioning the ball head 120 with the clamping element 110, thereby preventing the ball head 120 from separating from the clamping element 110.

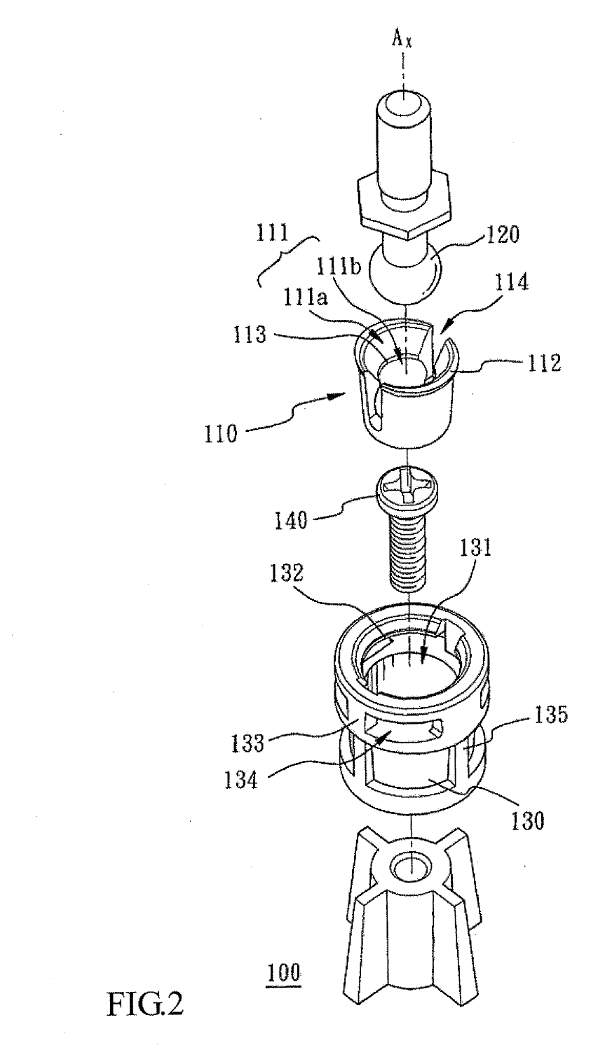

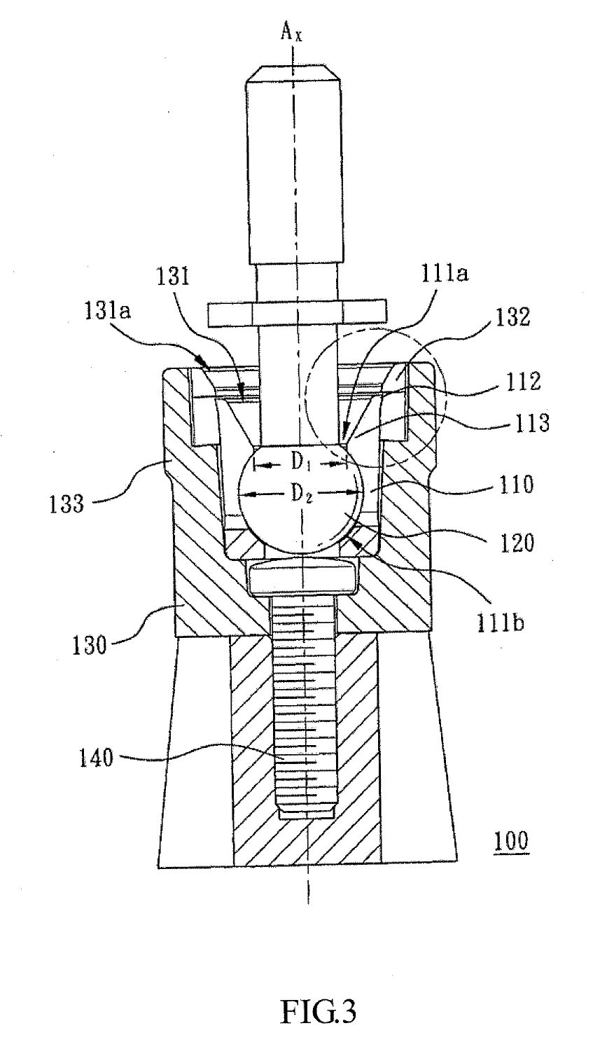

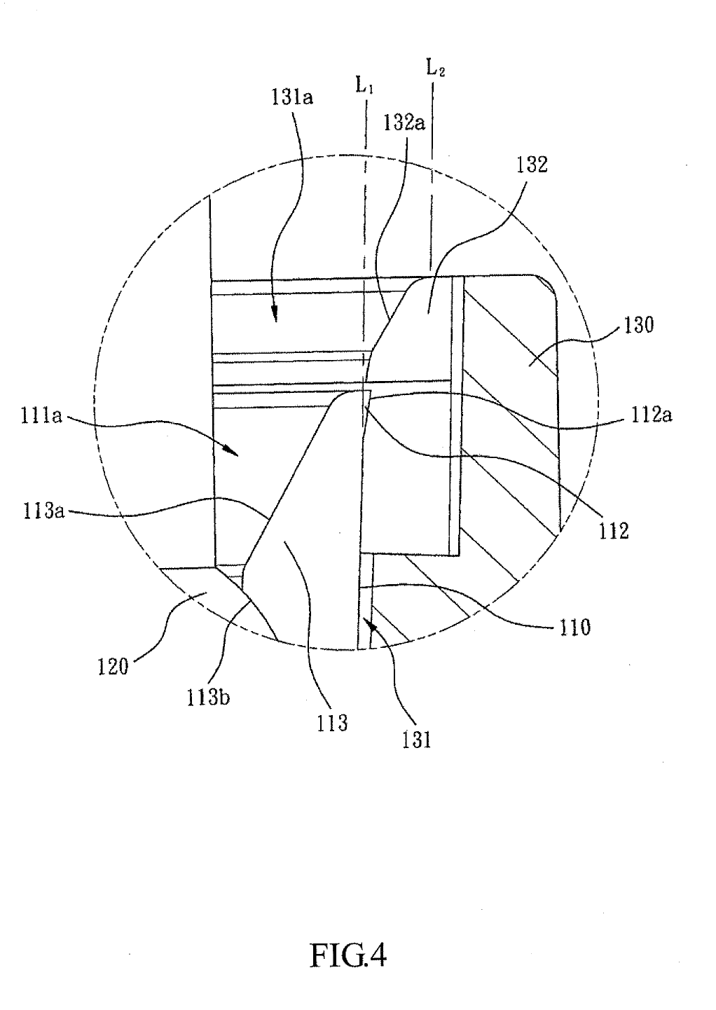

FIG. 2 is an exploded view of the fixing base structure of a vehicular lamp adjustment mechanism of FIG. 1. FIG. 3 is a cross-sectional view of the fixing base structure of a vehicular lamp adjustment mechanism taken along line 1-1 in FIG. 1. FIG. 4 is a partial enlarged view of the fixing base structure of a vehicular lamp adjustment mechanism of FIG. 3. Referring to FIG. 2 through FIG. 4, the clamping element 110 further comprises a ball head chamber 111, a flange 112, and a positioning portion 113.

The ball head chamber 111 is formed on the clamping element 110. The ball head chamber 111 has an opening 111a and a spherical space 111b. As described by its name, the spherical space 111b accommodates a spherical object. The opening 111a refers to a space immediately above the spherical space 111b, wherein the space has a larger caliber than the spherical space 111b.

In the two paragraphs below, referring to FIG. 4, the “outer side” is defined as the right side on an auxiliary line L1, whereas the “inner side” is defined as the left side on the auxiliary line L1. The flange 112 protrudes toward the outer side of the opening 111a of the ball head chamber 111. In this embodiment, the flange 112 of the fixing base structure of a vehicular lamp adjustment mechanism 100 regularly protrudes toward the outer side of the opening 111a of the ball head chamber 111 and is circumferentially disposed at the periphery on the outer side of the opening 111a of the ball head chamber 111.

The positioning portion 113 protrudes toward the inner side of the opening 111a of the ball head chamber 111. In this embodiment, the positioning portion 113 and the flange 112 of the fixing base structure of a vehicular lamp adjustment mechanism 100 are similar in that both protrude regularly, but they differ from each other in that the positioning portion 113 protrudes toward the inner side of the opening 111a of the ball head chamber 111 and is circumferentially disposed on the inner side of the opening 111a of the ball head chamber 111 so as to be opposite to the other periphery of the flange 112.

The ball head 120 is clamped and confined to the ball head chamber 111. by means of the positioning portion 113 of the clamping element 110. The ball head 120 is a full ball head (shown) or a three-fourths ball head (not shown).

The fixing base 130 receives the clamping element 110. The fixing base 130 further comprises a receiving chamber 131 and an engaging portion 132. The receiving chamber 131 is formed on the fixing base 130. The receiving chamber 131 has an opening 131a. The clamping element 110 and the ball head 120 are tightly received in the receiving chamber 131.

In this paragraph, referring to FIG. 4, the “outer side” is defined as the right side on an auxiliary line L2, whereas the “inner side” is defined as the left side on the auxiliary line L2. The engaging portion 132 protrudes toward the inner side of the opening 131a of the receiving chamber 131. In this embodiment, the engaging portion 132 of the fixing base structure of a vehicular lamp adjustment mechanism 100 regularly protrudes toward the inner side of the opening 131a of the receiving chamber 131 and is circumferentially disposed at the periphery on the inner side of the opening 131a of the receiving chamber 131. Mutual engagement and positioning are effectuated between the engaging portion 132 and the flange 112 of the clamping element 110, such that the engaging portion 132 can prevent the flange 112 of the clamping element 110 from escaping from the receiving chamber 131.

The positioning portion 113 of the clamping element 110 has an oblique conical surface 113a slanting and extending toward the center. The oblique conical surface 113a enables the ball head 120 to enter the spherical space 111b of the ball head chamber 111 by following the oblique conical surface 113a, so as to reduce the difficulty in installation.

The positioning portion 113 of the clamping element 110 has an arcuate conical surface 113b correspondingly connected to the oblique conical surface 113a. The least diameter D1 between the arcuate conical surfaces 113b of the positioning portion 113 is less than the diameter D2 of the spherical space 111b of the ball head chamber 111. First, the arcuate conical surface 113b of the positioning portion 113 can adapt to the shape of the ball head 120, such that the ball head 120, whether a full ball head (shown) or a three-fourths ball head (not shown), is confined to the spherical space 111b of the ball head chamber 111 by means of the arcuate conical surface 113b of the positioning portion 113. Moreover, the least diameter D1 between the arcuate conical surfaces 113b of the positioning portion 113 is less than the diameter D2 of the spherical space 111b of the ball head chamber 111, so as to prevent the escape of the ball head 120 clamped and confined to the ball head chamber 111 by means of the positioning portion 113.

A point to note is that the engaging portion 132 of the fixing base 130 also has an oblique conical surface 132a. The oblique conical surface 132a is correspondingly connected to the oblique conical surface 113a of the positioning portion 113 of the clamping element 110. The clamping element 110 enters the receiving chamber 131 by following the oblique conical surface 132a of the engaging portion 132 of the fixing base 130, so as to reduce the difficulty in installation.

The flange 112 of the clamping element 110 has an oblique conical surface 112a corresponding to the oblique conical surface 132a of the engaging portion 132. The oblique conical surface 112a of the flange 112 renders it more difficult for the flange 112 to escape from the receiving chamber 131. That is to say, to escape from the receiving chamber 131, the clamping element 110 has to damage the oblique conical surface 112a on the outer side of the flange 112 of the clamping element 110. As a result, the stability of the clamping element 110 positioned in the receiving chamber 131 is greatly enhanced.

In addition to the above elements, the fixing base structure of a vehicular lamp adjustment mechanism 100 in this embodiment further comprises a hierarchical structure 133, a plurality of hollow portions 134, at least one extension-contraction slot 114, a plurality of support portions 135, and a bolt 140.

The hierarchical structure 133 is integrally formed with the outer side of the opening 131a of the receiving chamber 131. The hollow portions 134 are formed in the hierarchical structure 133 to penetrate the hierarchical structure 133. Since the flange 112 of the clamping element 110 of the fixing base structure of a vehicular lamp adjustment mechanism 100 in this embodiment has room for slight outward expansion, it is necessary that the hollow portions 134 are formed at the fixing base 130. However, hollowing out the fixing base 130 in part reduces the structural strength of the fixing base 130 per se. Hence, the hierarchical structure 133 extends outward from the hollow portions 134 of the fixing base 130 of the fixing base structure of a vehicular lamp adjustment mechanism 100 in this embodiment to reinforce the fixing base 130.

The extension-contraction slots 114 are formed at the ball head chamber 111 of the clamping element 110. The extension-contraction slots 114 are designed to meet the need for installation of the ball head 120. Since the least diameter D1 between the arcuate conical surfaces 113b of the positioning portion 113 of the clamping element 110 is less than the diameter D2 of the spherical space Mb of the ball head chamber 111, the ball head 120 has to stretch the clamping element 110 outward in order to enter the spherical space 111b of the ball head chamber 111 and be installed therein. Hence, the extension-contraction slots 114 are formed at the ball head chamber 111 of the clamping element 110 to facilitate the outward expansion and deformation of the clamping element 110.

In this embodiment of the fixing base structure of a vehicular lamp adjustment mechanism 100, two said extension-contraction slots 114 are formed on two opposing sides of the ball head chamber 111 of the clamping element 110, respectively, such that it is easier for the ball head 120 to stretch the clamping element 110 outward. The extension-contraction slots 114 which are paired and symmetrical in position are conducive to uniform distribution of an outward deformation-enabling force across the clamping element 110, thereby preventing the clamping element 110 from irregular deformation and the resultant damage which might otherwise occur thereto because of uneven distribution of a force exerted thereon.

The support portions 135 are integrally fixed to the outer side of the fixing base 130. The support portions 135 extend in a direction parallel to a virtual central axis Ax of the fixing base 130. In this embodiment of the fixing base structure of a vehicular lamp adjustment mechanism 100, the purpose of the support portions 135 is to enhance the structural strength of the fixing base 130.

The bolt 140 is pivotally disposed at the bottom of the fixing base 130 for screwing the fixing base 130 to a preset position.

As indicated by the aforesaid embodiments of the fixing base structure of a vehicular lamp adjustment mechanism 100 of the present invention, given the ball head chamber 111 and the positioning portion 113 of the clamping element 110, the fixing base structure of a vehicular lamp adjustment mechanism 100 is fully applicable to the ball heads 120 of different specifications. Furthermore, the flange 112 of the clamping element 110 is engaged with the engaging portion 132 of the fixing base 130 to not only position the clamping element 110 in the fixing base 130, but also further prevent the ball head 120 from escaping from the ball head chamber 111. Moreover, various oblique conical surfaces and arcuate conical surfaces of the fixing base structure of a vehicular lamp adjustment mechanism 100 in this technical aspect play an important role in the operation of each related element. The oblique conical surface 112a of the flange 112 of the clamping element 110 greatly enhances the stability of the flange 112 positioned at the receiving chamber 131. The oblique conical surface 113a of the positioning portion 113 of the clamping element 110 reduces the difficulty in installation. The arcuate conical surface 113b of the positioning portion 113 of the clamping element 110 enables the ball head 120 to be positioned in the ball head chamber 111 better. Likewise, the oblique conical surface 132a of the engaging portion 132 of the fixing base 130 reduces the difficulty in installation.

The present invention is disclosed above by preferred embodiments. However, the preferred embodiments are not restrictive of the scope of the present invention. Hence, persons skilled in the art can make various changes and modifications to the aforesaid embodiments without departing from the spirit and scope of the present invention. Accordingly, the legal protection for the present invention should be defined by the appended claims.

What is claimed is:

1. A fixing base structure of a vehicular lamp adjustment mechanism, comprising a clamping element comprising:
a ball head chamber formed on the clamping element and having an opening and a spherical space;
a flange protruding toward an outer side of the opening of the ball head chamber; and
a positioning portion protruding toward an inner side of the opening of the ball head chamber, wherein an inner side of the positioning portion has an arcuate conical surface correspondingly connected to the ball head chamber, and a least diameter between the arcuate conical surfaces is less than a diameter of the spherical space of the ball head chamber;
a ball head clamped and confined to the ball head chamber by the positioning portion of the clamping element; and
a fixing base for receiving the clamping element, the fixing base comprising:
a receiving chamber formed on the fixing base and having an opening, wherein the clamping element is tightly disposed in the receiving chamber; and
an engaging portion protruding toward an inner side of the opening of the receiving chamber for engaging and positioning the flange of the clamping element.

2. The fixing base structure of a vehicular lamp adjustment mechanism of claim 1, further comprising a hierarchical structure integrally formed with an outer side of the opening of the receiving chamber.

3. The fixing base structure of a vehicular lamp adjustment mechanism of claim 2, further comprising a plurality of hollow portions formed in the hierarchical structure to penetrate the hierarchical structure.

4. The fixing base structure of a vehicular lamp adjustment mechanism of claim 1, further comprising at least an extension-contraction slot formed at the ball head chamber of the clamping element.

5. The fixing base structure of a vehicular lamp adjustment mechanism of claim 1, further comprising two extension-contraction slots formed on two opposing sides of the ball head chamber of the clamping element, respectively.

6. The fixing base structure of a vehicular lamp adjustment mechanism of claim 1, wherein the positioning portion is circumferentially fixed to the inner side of the opening of the ball head chamber.

7. The fixing base structure of a vehicular lamp adjustment mechanism of claim 1, wherein the positioning portion has an oblique conical surface slanting and extending toward a center.

8. The fixing base structure of a vehicular lamp adjustment mechanism of claim 7, wherein the engaging portion has an oblique conical surface correspondingly connected to the oblique conical surface of the positioning portion.

9. The fixing base structure of a vehicular lamp adjustment mechanism of claim 8, wherein an outer side of the flange has an oblique conical surface corresponding to the oblique conical surface on the inner side of the engaging portion.

10. The fixing base structure of a vehicular lamp adjustment mechanism of claim 1, further comprising a plurality of support portions integrally fixed to an outer side of the fixing base and extending in a direction parallel to a virtual central axis of the fixing base.

11. The fixing base structure of a vehicular lamp adjustment mechanism of claim 1, wherein the ball head is a full ball head.

12. The fixing base structure of a vehicular lamp adjustment mechanism of claim 1, wherein the ball head is a three-fourths ball head.

13. The fixing base structure of a vehicular lamp adjustment mechanism of claim 1, further comprising a bolt pivotally disposed at a bottom of the fixing base for screwing the fixing base to a preset position.
